(19) United States
(12) Patent Application Publication
(10) Pub. No.: US 2018/0274437 A1
(43) Pub. Date: Sep. 27, 2018

(54) COMPRESSION RATIO ADJUSTING APPARATUS FOR INTERNAL COMBUSTION ENGINE AND METHOD FOR CONTROLLING COMPRESSION RATIO ADJUSTING APPARATUS FOR INTERNAL COMBUSTION ENGINE

(71) Applicant: HITACHI AUTOMOTIVE SYSTEMS, LTD., Hitachinaka-shi, Ibaraki (JP)

(72) Inventors: Masahiro SHOJI, Atsugi-shi, Kanagawa (JP); Makoto NAKAMURA, Zushi-shi, Kanagawa (JP)

(73) Assignee: HITACHI AUTOMOTIVE SYSTEMS, LTD., Hitachinaka-shi, Ibaraki (JP)

(21) Appl. No.: 15/756,128

(22) PCT Filed: Aug. 31, 2016
(86) PCT No.: PCT/JP2016/075438

§ 371 Date: Feb. 28, 2018

(30) Foreign Application Priority Data
Sep. 3, 2015 (JP) 2015-173660

(51) Int. Cl. F02B 75/04; F02D 15/02

(52) U.S. Cl. CPC F02B 75/045; F02D 2200/602; F02D 2700/03; F02D 15/02

(57) ABSTRACT

An object of the present invention is to provide a novel compression ratio adjusting apparatus for an internal combustion engine that can improve a knocking resistance performance and also prevent or cut down an increase in a temperature of exhaust gas. The compression ratio adjusting apparatus is configured to relatively decrease a mechanical compression ratio in a high load area of the internal combustion engine and also adjust a mechanical expansion ratio at this time to a relatively high ratio. According to this configuration, the compression ratio adjusting apparatus performs control of decreasing the mechanical compression ratio in the high load area of the internal combustion engine and also increasing the mechanical expansion ratio at this time, thereby succeeding in improving the knocking resistance performance and also preventing or cutting down the increase in the temperature of the exhaust gas, thus succeeding in reducing thermal damage on a part in an exhaust system.

### TECHNICAL FIELD

The present invention relates to a compression ratio adjusting apparatus for a four cycle internal combustion engine, and a method for controlling the compression ratio adjusting apparatus for the internal combustion engine, and, in particular, to a compression ratio adjusting apparatus for an internal combustion engine that includes a variable compression ratio mechanism configured to change positions of a piston at a top dead center and a bottom dead center, and a method for controlling the compression ratio adjusting apparatus for the internal combustion ratio.

### BACKGROUND ART

As a conventional compression ratio adjusting apparatus for an internal combustion engine, one proposed method is to improve various performances of the engine by a combination of control of a variable compression ratio mechanism that variably controls a geometric compression ratio, i.e., a mechanical compression ratio of the internal combustion engine, and control of a variable valve actuating mechanism that variably controls an opening/closing timing of an intake/exhaust valve determining an actual compression ratio. For example, a compression ratio adjusting apparatus for an internal combustion engine discussed in Japanese Patent Application Public Disclosure No. 2002-276446 (PTL 1) includes the variable valve actuating mechanism for variably controlling the closing timing of the intake/exhaust valve and also includes the variable compression ratio mechanism that variably controls the compression ratio.

### CITATION LIST

### Patent Literature

PTL 1: Japanese Patent Application Public Disclosure No. 2002-276446

### SUMMARY OF INVENTION

### Technical Problem

Then, FIG. 8 in PTL 1 illustrates a posture of the mechanism at a compression top dead center. A left portion in FIG. 8 illustrates a piston position at the compression top dead center in high mechanical compression ratio control (the piston position is slightly high), and a right portion in FIG. 8 illustrates a piston position at the compression top dead center in low mechanical compression ratio control (the piston position is slightly low). Then, focusing on positions at an exhaust top dead center, the piston positions at the exhaust top dead center coincide with the respective piston positions at the compression top dead center illustrated in FIG. 8 in both the high mechanism compression ratio control and the low mechanical compression ratio control.

This is because the variable compression ratio mechanism discussed in PTL 1 is a mechanism operating based on one cycle set to a crank angle of 360 degrees, and therefore the piston position at the compression top dead center and the piston position at the exhaust (intake) top dead center coincide with each other in principle. Further, for the same reason, a piston position at an intake bottom dead center and a piston position at an expansion bottom dead center also coincide with each other. This means that a compression stroke from the piston position at the intake bottom dead center to the piston position at the compression top dead center, and an expansion stroke from the piston position at the compression top dead center to the piston position at the expansion bottom dead center also match each other any time. Therefore, the mechanical compression ratio and the mechanical expansion ratio also match each other in principle.

Then, the compression ratio adjusting apparatus configured in this manner may cause inconvenience like a problem that will be described below.

For example, in a high load area of the internal combustion engine, an attempt to decrease the mechanical compression ratio to improve a knocking resistance performance leads to an unintentional reduction in the mechanical expansion ratio to the same value as the mechanical compression ratio according thereto since the mechanical compression ratio and the mechanical expansion ratio match each other. As a result, the above-described compression ratio adjusting apparatus may raise a new problem of increasing a temperature of exhaust gas in the high load area of the internal combustion engine and increasing a possibility of occurrence of heat damage on a part in an exhaust system such as an exhaust manifold and an exhaust gas purification catalyst.

An object of the present invention is to provide a novel compression ratio adjusting apparatus for an internal combustion engine capable of preventing or cutting down the increase in the temperature of the exhaust gas while improving the knocking resistance performance and a novel method for controlling the compression ratio adjusting apparatus for the internal combustion engine.

### Solution to Problem

One aspect of the present invention is characterized by being configured to relatively decrease the mechanical compression ratio in the high load area of the internal combustion engine and also adjust the mechanical expansion ratio to a relatively high ratio at this time.

According to the one aspect of the present invention, the compression ratio adjusting apparatus performs control of decreasing the mechanical compression ratio in the high load area of the internal combustion engine and also adjusting the mechanical expansion ratio to the high ratio at this time, thereby achieving the improvement of the knocking resistance performance and also realizing the prevention or cut-down of the temperature of the exhaust gas.

### BRIEF DESCRIPTION OF DRAWINGS

FIG. 1 schematically illustrates an entire compression ratio adjusting apparatus according to the present invention.

FIG. 2 is a side view of main portions that illustrates a part of the compression ratio adjusting apparatus according to the present invention in cross section.

FIGS. 3(A) and 3(B) are front views of a piston position change mechanism with a front cover removed therefrom, and, in particular, FIGS. 3(A) and 3(B) illustrate a maximum delay angle control state and a maximum advance angle state, respectively.

FIGS. 4(A) to 4(C) illustrate an operation of converting a phase of a control shaft by a variable compression ratio mechanism used in first and second embodiments, and, in particular, FIGS. 4(A) to 4(C) illustrate states when an eccentric rotational phase of the control shaft is controlled to a control phase αa (for example, 43 degrees), a control phase αb (for example, 71 degrees), and a control phase αc (for example, 100 degrees), respectively, at a rotational angle of a crankshaft (X=360 degrees) at which a crank pin faces approximately right above the crankshaft around a compression top dead center.

FIG. 5 illustrates a characteristic of a change in a height position of a piston in relation to the rotational angle of the crankshaft according to the first embodiment.

FIGS. 6(A) to 6(H) illustrate an operation of the variable compression ratio mechanism according to the first embodiment. FIGS. 6(A) to 6(D) illustrate piston positions when a vane rotor is in the maximum delay angle state (the control phase αa), and, in particular, illustrate a position at an exhaust (intake) top dead center, a position at an intake bottom dead center, a position at the compression top dead center, and a position at an expansion bottom dead center, respectively. Further, FIGS. 6(E) to 6(H) illustrate piston positions when the vane rotor is in an intermediate angle state (the control phase αb), and, in particular, illustrate states in which the piston position is located at a position at the exhaust (intake) top dead center, a position at the intake bottom dead center, a position at the compression top dead center, and a position at the expansion bottom dead center, respectively.

FIG. 7 is a control flowchart in which control according to the first embodiment is performed.

FIG. 8 illustrates a characteristic of the change in the height position of the piston in relation to the rotational. angle of the crankshaft according to the second embodiment.

FIGS. 9(A) to 9(H) illustrate an operation of the variable compression ratio mechanism according to the second embodiment. FIGS. 9(A) to 9(D) illustrate piston positions when the vane rotor is in the maximum delay angle state (the control phase αa), and, in particular, illustrate a position at the exhaust (intake) top dead center, a position at the intake bottom dead center, a position at the compression top dead center, and a position at the expansion bottom dead center, respectively. Further, FIGS. 9(E) to 9(H) illustrate piston positions when the vane rotor is in the maximum advance angle state (the control phase αc), and, in particular, illustrate states in which the piston position is located at a position at the exhaust (intake) top dead center, a position at the intake bottom dead center, a position at the compression top dead center, and a position at the expansion bottom dead center, respectively.

FIG. 10 is a control flowchart in which control according to the second embodiment is performed.

### DESCRIPTION OF EMBODIMENTS

In the following description, embodiments of the present invention will be described in detail with reference to the drawings, but the present invention is not limited to the embodiments that will be described below and a range thereof also includes various modifications and applications within a technical concept of the present invention.

### First Embodiment

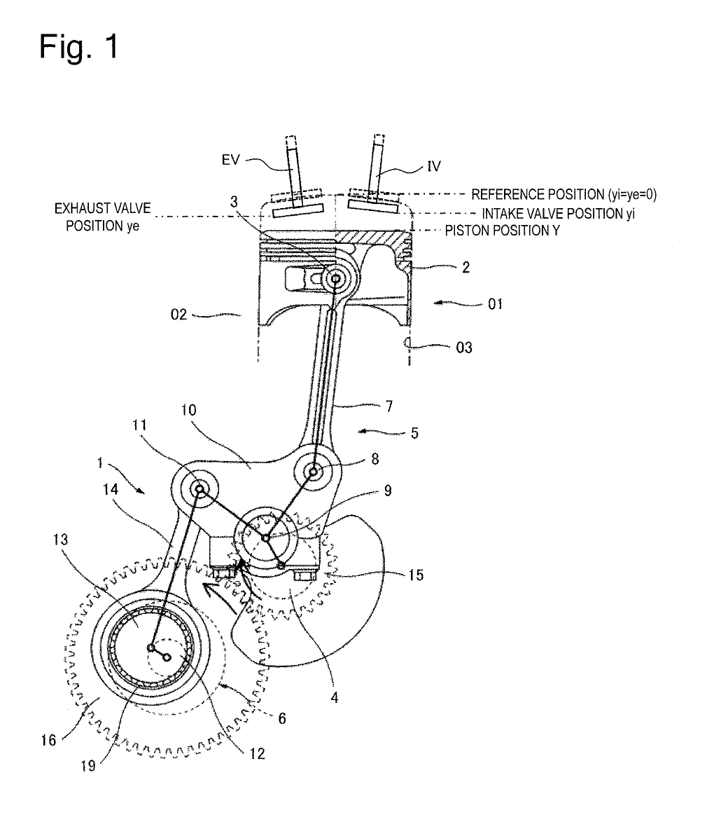

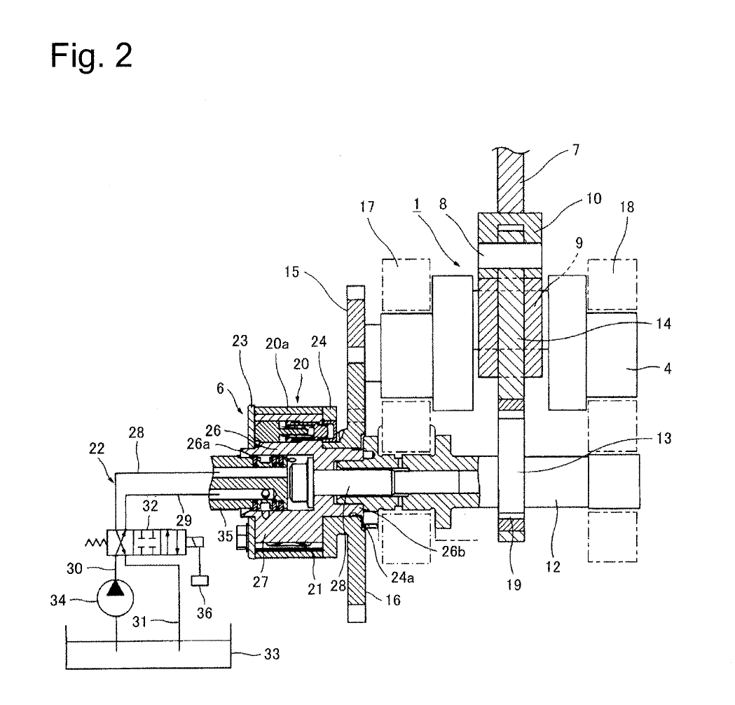

First, a first embodiment of the present invention will be described. FIGS. 1 and 2 schematically illustrate a configuration of a variable compression ratio mechanism. FIG. 1 illustrates the variable compression ratio mechanism as viewed from a right side of FIG. 2.

An internal combustion engine 01 includes a piston 2 and a crankshaft 4. The piston 2 reciprocates vertically along a cylinder bore 03 formed inside a cylinder block 02. The crankshaft 4 is rotationally driven by the vertical movement of the piston 2 via a piston pin 3 and a link mechanism 5 of a variable compression ratio mechanism 1, which will be described below. A space defined on a crown surface of the piston 2 illustrated in FIG. 1 between the piston 2 and a combustion chamber boundary line indicated by an alternate long and short dash line is a cylinder inner volume (a volume in a combustion chamber).

Further, an intake valve IV and an exhaust valve EV are provided in the combustion chamber, and are each opened and closed by a not-illustrated cam shaft. When being lifted toward a piston 2 side (a lower side), these intake valve IV and exhaust valve EV approach the crown surface of the piston as seen from FIG. 1. Now, a lift amount of the intake valve IV is expressed as a position yi from a reference position (yi =ye=0) in a direction in which the piston slidably moves, and a lift amount of the exhaust valve EV is expressed as a position ye from the reference position in the direction in which the piston slidably moved. Assume that Y represents a position of the piston 2 at this time. The reference position corresponds to a position at which both the intake valve IV and the exhaust valve EV are closed without being lifted. Then, an upward displacement of the piston position Y to the position yi of the intake valve IV or the position ye of the exhaust valve EV at some crank angle leads to occurrence of interference between the crown surface of the piston and the intake/exhaust valve.

The variable compression ratio mechanism 1 includes the link mechanism 5 including a plurality of links, a piston position change mechanism 6 that changes a posture of the link mechanism 5, and the like. The link mechanism 5 includes an upper link 7, a lower link 10, and a control link 14. The upper link 7 is a first link coupled with the piston 2 via the piston pin 3. The lower link 10 is a second link swingably coupled with the upper link 7 via a first coupling pin 8 and is also rotatably coupled with the crankshaft 4 via a crank pin 9. The control link 14 is a third link swingably coupled with the lower link 10 via a second coupling pin 11, and is also rotatably coupled with an eccentric cam portion 13 of a control shaft 12.

Further, a small-diameter first gear wheel 15, which is a driving rotational member, is fixed to a front end portion of the crankshaft 4 as illustrated in FIGS. 1 and 2 while a large-diameter second gear wheel 16, which is a driven rotational member, is provided on a front end portion side of the control shaft 2, and the variable compression ratio mechanism 1 is configured in such a manner that the first gear wheel 15 and the second gear wheel 16 are meshed with each other to allow a rotational force of the crankshaft 4 to be transmitted to the control shaft 12 via the piston position change mechanism 6.

The first gear wheel 15 has an outer diameter that is approximately half of an outer diameter of the second gear wheel 16, and therefore a rotational speed of the crankshaft 4 is arranged so as to be transmitted to the control shaft 12 while being reduced to a half angular speed due to a difference between the outer diameters of the first gear wheel 15 and the second gear wheel 16. The control shaft 12 is configured in such a manner that a phase thereof with respect to the second gear wheel 16 is changed, i.e., a relative rotational phase with respect to the crankshaft 4 is changed by the piston position change mechanism 6.

As illustrated in FIG. 2, the crankshaft 4 and the control shaft 12 are rotatably supported by common two bearings 17 and 18 provided on the cylinder block in front of and behind them. Further, the eccentric cam portion 13 is rotatably coupled with a large-diameter portion formed at a lower end portion of the control link 14 via a needle bearing 19.

The piston position change mechanism 6 is, for example, configured similarly to a hydraulic (vane-type) variable valve actuating mechanism discussed in Japanese Patent Application Public Disclosure No. 2012-225287 previously applied by the present applicant, which will be briefly described now.

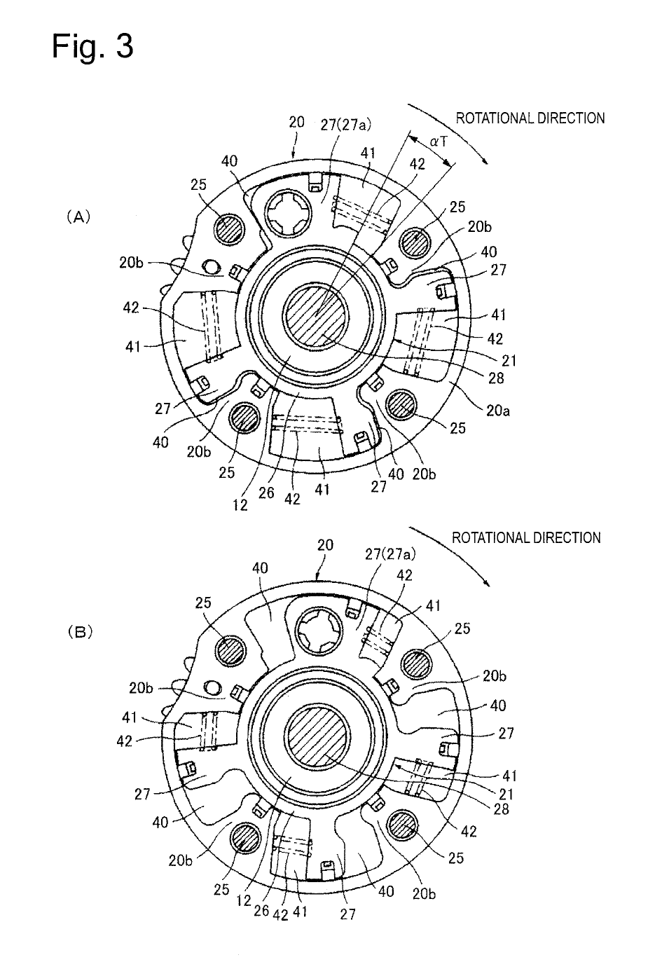

That is, as illustrated in FIGS. 2, and 3(A) and 3(B), this piston position change mechanism 6 includes a housing 20, a vane rotor 21, and a hydraulic circuit 22. The second gear wheel 16 is fixed to the housing 20. The vane rotor 21 is relatively ratably contained in the housing 20 and fixed to one end portion of the control shaft 12. The hydraulic circuit 22 hydraulically rotates the vane rotor 21 in a normal direction and an opposite direction.

The housing 20 includes a cylindrical housing main body 20a, which is closed at a front end opening thereof by a disk-shaped front cover 23 and is also closed at a rear end opening thereof by a disk-shaped rear cover 24. Further, shoes 20b, which are four partition walls, are formed so as to protrude inward at positions of approximately 90 degrees in a circumferential direction of an inner peripheral surface of the housing main body 20a.

The rear cover 24 is disposed at a central position of the second gear wheel 16 integrally with each other, and is fixed at an outer peripheral portion thereof to the housing main body 20a and the front cover 23 by being fastened together therewith with use of four bolts 25. Further, a large-diameter bearing hole 24a is formed so as to axially penetrate through an approximately central portion of the rear cover 24. An outer periphery of a cylindrical portion of the vane rotor 21 is borne by the bearing hole 24a.

The vane rotor 21 includes a cylindrical rotor 26 and four vanes 27. The rotor 26 includes a bolt insertion hole at a center thereof. The vanes 72 are integrally provided at positions of approximately 90 degrees in a circumferential direction of an outer peripheral surface of the rotor 26. The rotor 26 includes a small-diameter cylindrical portion 26a on a front end side thereof, and a small-diameter cylindrical portion 26b on a rear end side thereof. The small-diameter cylindrical portion 26a is rotatably supported in a central support hole of the front cover 23, while the cylindrical portion 26b is rotatably supported in the bearing hole 24a of the above-described rear cover 24.

Further, the vane rotor 21 is fixed to a front end portion of the control shaft 12 from an axial direction with use of a fixation bolt 28 inserted in the bolt insertion hole of the rotor 26 from the axial direction. Further, each of the vanes 27 is arranged between the individual shoes 20b, and a seal member and a plate spring are each fixedly attached and held in an elongated holding groove formed in an axial direction of an outer surface of each of the vanes 27. The seal member is in sliding contact with an inner peripheral surface of the above-described housing main body 20a. The plate spring presses this seal member in a direction of the inner peripheral surface of the housing main body. Further, four advance angle chambers 40 and four delay angle chambers 41 are individually defined between both sides of each of these vanes 27 and both side surfaces of each of the shoes 20b.

As illustrated in FIG. 2, the hydraulic circuit 22 includes two hydraulic passage systems, namely, a first hydraulic passage 28 and a second hydraulic passage 29. The first hydraulic passage 28 supplies and discharges a hydraulic pressure of hydraulic oil to and from each of the advance angle chambers 40. The second hydraulic passage 29 supplies and discharges the hydraulic pressure of the hydraulic oil to and from each of the delay angle chambers 41. A supply passage 30 and a drain passage 31 are each connected to both these hydraulic passages 28 and 29 via an electromagnetic switching valve 32 for switching the passage. A one-way oil pump 34, which pressure-feeds the oil contained in an oil pan 33, is provided in the supply passage 30, and a downstream end of the drain passage 31 is in communication with the oil pan 33.

The first and second hydraulic passages 28 and 29 are formed inside a passage forming portion provided on the front cover 23 side, and one end portion of each of them is in communication with inside the above-described rotor 26 via a columnar portion 35 disposed by being inserted in an internal support hole from the small-diameter cylindrical portion 26a of the rotor 26 in the above-described passage forming portion while an opposite end portion is connected to the above-described electromagnetic switching valve 32.

The first hydraulic passage 28 includes not-illustrated four branch passages in communication with the respective advance angle delay chambers 40, while the second hydraulic passage 29 includes second oil passages in communication with the respective delay angle chambers 41. The electromagnetic switching valve 32 is a four-port three-position type valve, and an internal valve body thereof is configured to perform control of relatively switching each of the hydraulic passages 28 and 29, and the supply passage 30 and the drain passage 31, and is also configured to be switched to be activated according to a control signal from a control unit 36.

Then, the variable compression ratio mechanism 1 is configured to change the relative rotational phase of the vane rotor 21 (the control shaft 12) with respect to the crankshaft 4 by selectively supplying the hydraulic oil to each of the advance angle chambers 40 and each of the delay angle chambers 41 by the switched activation of the electromagnetic switching valve 32. Further, four coil springs 42 are each attached in each of the delay angle chambers 41. The coil springs 42 constantly bias the vane rotor 21 in a delay angle direction.

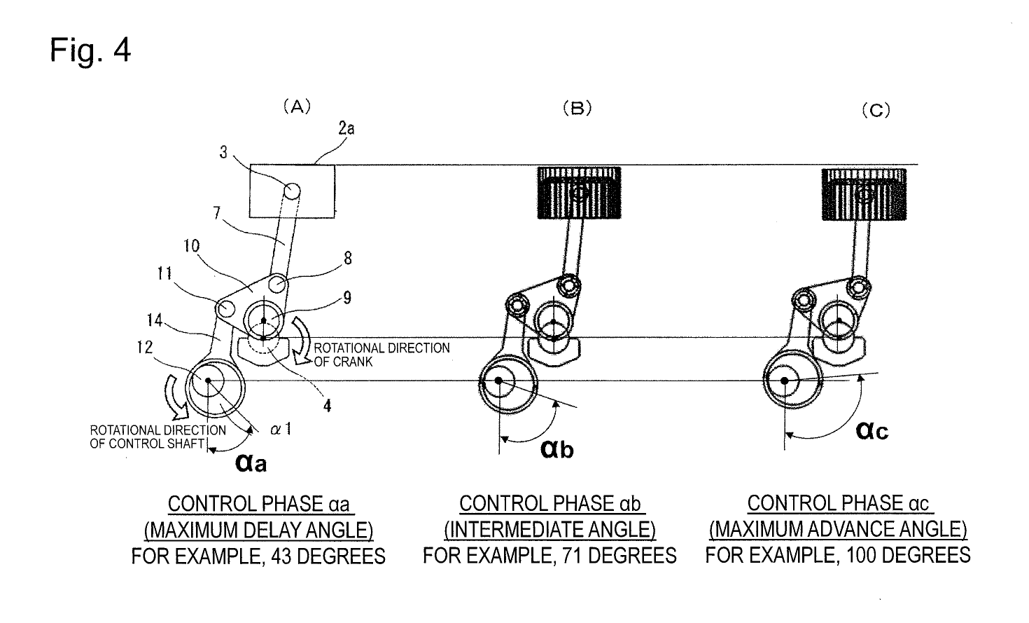

FIGS. 4(A) to 4(C) illustrate the second gear wheel 16 and the control shaft 12 when the relative rotational phase therebetween is changed. In these drawings, the first and second gear wheels 15 and 16 and the like are omitted. The present embodiment is configured to be able to change this relative rotational phase by control of converting the relative rotational phase that is performed by the above-described piston position change mechanism 6, but can also change the relative rotational phase by relatively changing an attachment relationship between the above-described second gear wheel 16 and the control shaft 12 (the eccentric cam portion 13).

These drawings, FIGS. 4(A) to 4(C) each illustrate a posture when the crankshaft 4 is rotated in the clockwise direction without changing the relative phase between the second gear wheel 16 and the crank shaft 12 illustrated in FIG. 1, is further rotated once from a position where the crank pin 9 is oriented right above it (a crank angle X=0 degrees and around an exhaust (intake) top dead center), and is then located at a position where the crank pin 9 is oriented right above it again (X=360 degrees and around a compression top dead center).

At this time, in FIG. 4A, an eccentricity direction of the eccentric cam portion 13 is located at a position changed by, for example, 43 degrees in the counterclockwise direction from a direction right below the control shaft 12. This angular position corresponds to a maximum delay angle state in which the phase is maximally delayed. Further, in FIG. 4(B), the eccentricity direction of the eccentric cam portion 13 is located at a position changed by, for example, 71 degrees in the counterclockwise direction from the direction right below the control shaft 12. This angular position corresponds to a state in which the phase is advanced by 28 degrees compared to FIG. 4(A) and an intermediate angle state. Further, in FIG. 4(C), the eccentricity direction of the eccentric cam portion 13 is located at a position changed by, for example, 100 degrees in the counterclockwise direction from the direction right below the control shaft 12. This corresponds to a state in which the phase is advanced by 57 degrees compared to FIG. 4(A) (further advanced by 29 degrees from FIG. 4B), and this angular position corresponds to a maximum advance angle state in which the phase is maximally advanced.

In other words, the maximally delayed state is FIG. 4(A), the maximally advanced state is FIG. 4(C), and the state therebetween is FIG. 4(B). In the present example, the rotational direction of the eccentric cam portion 13 is the counterclockwise direction in FIGS. 4(A) to 4(C), and therefore the counterclockwise direction is assumed to be an advance angle direction.

Then, an operation of the phase change mechanism 6 (the piston position change mechanism) capable of achieving a conversion between, for example, the control phase αa illustrated in FIG. 4(A) and the control phase αc illustrated in FIG. 4(C) will be described with reference to FIGS. 3(A) and 3(B).

These drawings, FIGS. 3(A) and 3(B) illustrate the phase change mechanism 6 as viewed from a left side of FIG. 2, and the second gear wheel 16 is rotated in the clockwise direction in FIGS. 3(A) and 3(B). FIGS. 3(A) and 3(B) illustrate a maximum delay angle position (corresponding to the control phase αa) and a maximum advance angle position (corresponding to the control phase αc) of the vane rotor 21 of the piston position change mechanism 6, respectively, and the phase change mechanism 6 is configured in such a manner that both these maximum delay angle position and maximum advance angle position are regulated by stoppers (a delay angle-side stopper and an advance angle-side stopper) with both sides of the vane 27 (27a) having a largest widened width in abutment with one end surface and an opposite end surface of each of the shoes 20b adjacent thereto.

Then, the vane rotor 21 is configured to be mechanically stabilized around the maximum advance angle position by a spring force of each of the coil springs 42 as illustrated in FIG. 3(A). In other words, a default position is set to the maximum advance angle position. Then, supposing that a phase conversion angle αT of the piston position change mechanism 6 is αT=αcαa, such as 57 degrees (=100 degrees −43 degrees), a desired conversion angle αT (for example, 71 degrees) can be realized by the conversion between the control phase αc and the control phase αa.

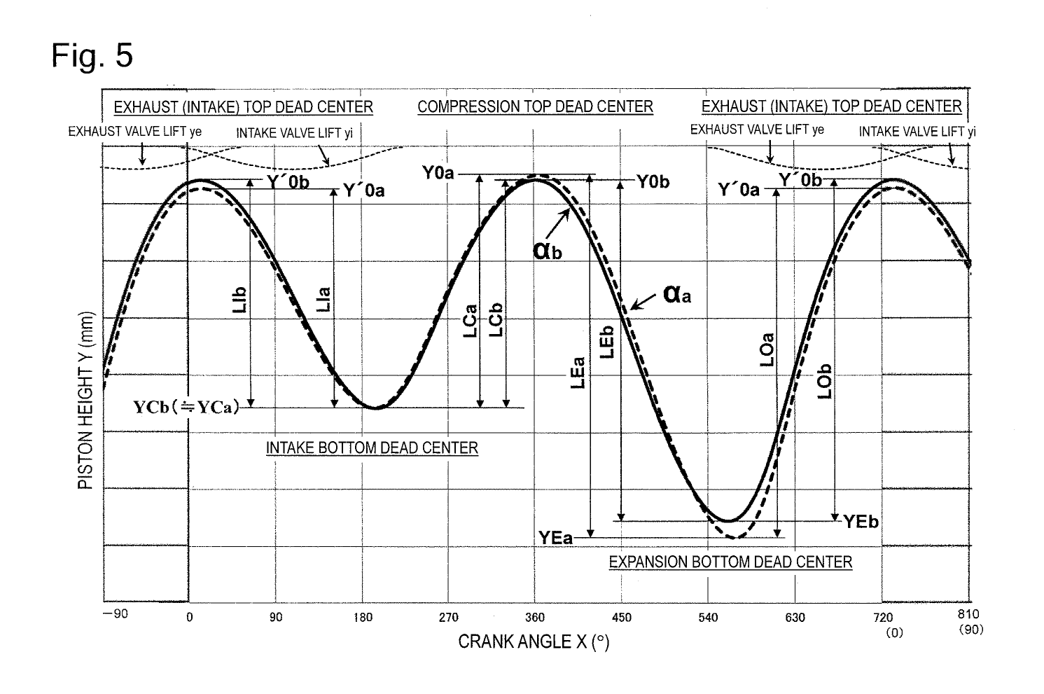

FIG. 5 illustrates a characteristic of a change in the piston position. In FIG. 5, the crank pin 9 is located right above the crankshaft 4 when the crank angle X is 0 degrees, and the piston 2 reaches the exhaust (intake) top dead center around there.

When the crank angle X starts rotating from 0 degrees in the clockwise direction, the exhaust valve EV is completely closed as indicated by an exhaust vale lift curve (ye). Further, an intake lift curve (yi) of the intake valve IV, which has started an opening operation before 0 degrees, is further increasingly lifted and introduces fresh air (or an air-fuel mixture) from an intake port. Next, the piston 2 reaches an intake bottom dead center around a position where the crank angle X reaches 180 degrees, and the lift of the intake valve IV little remains around there. Now, a cycle from the intake top dead center to the intake bottom dead center will be referred to as an intake stroke.

When the crankshaft 4 is further rotated, the intake valve IV is completely closed and the air-fuel mixture in the cylinder is compressed along therewith, and the piston 2 reaches the compression top dead center around a position where the crank angle X reaches 360 degrees (the crank pin 9 reaches the position right above the crankshaft 4 again). Now, a cycle from the intake bottom dead center to the compression top dead center will be referred to as a compression stroke.

After that, spark ignition (or compression ignition) is carried out and combustion is started, and the piston 2 is being pressed down by a combustion pressure thereof and reaches an expansion bottom dead center around a position where the crank angle X reaches 540 degrees. Now, a cycle from the compression top dead center to the expansion bottom dead center will be referred to as an expansion stroke.

An opening operation of the exhaust valve EV is started around this expansion bottom dead center. Then, combusted gas (exhaust gas) is emitted from an exhaust port together with a re-rise of the piston 2, and the crank angle X corresponding to around the exhaust (intake) top dead center returns to a position of 720 degrees (=0 degrees) (the crank pin 9 is located right above the crankshaft 4) again. Now, a cycle from the expansion bottom dead center to the exhaust (intake) top dead center will be referred to as an exhaust stroke.

In the above-described manner, the compression ratio adjusting apparatus operates as a four cycle mechanism, and periodically operates based on one cycle set to the crank angle (X) 720 degrees. In PTL 1, the compression ratio adjusting apparatus periodically operates based on one cycle set to the crank angle (X) 360 degrees, and therefore has low flexibility for the piston stroke characteristic. On the other hand, in the present embodiment, the compression ratio adjusting apparatus operates based on one cycle set to the crank angle (X) 720 degrees, and therefore allows a mechanical compression ratio and a mechanical expansion ratio to be set differently. For example, as will be described below, the present embodiment allows the compression ratio adjusting apparatus to prevent or cut down an increase in a temperature of exhaust gas along with improving a knocking resistance performance by having a relationship of the mechanical compression ratio<the mechanical expansion ratio in a high load area.

In FIG. 5, a solid line represents a piston stroke characteristic (a piston crown surface position change characteristic) in the control phase αb (the intermediate angle) illustrated in FIG. 4(B), and a broken line represents a piston stroke characteristic (a piston crown surface position change characteristic) in the control phase αa (the maximum delay angle) illustrated in FIG. 4(A).

Focusing on the piston position at the compression top dead center, a piston position (Y0a) in the control phase αa indicated by the broken line is located at a relatively high position, and a piston position (Y0b) in the control phase αb indicated by the solid line is located at a relatively low position. As a cylinder inner volume (V0) at the compression top dead center, the combustion chamber has cylinder inner volumes (V0a) and (V0b) respectively corresponding to the above-described compression top dead center positions, and the cylinder inner volume (V0a) in the control phase αa in which the piston position at the compression top dead center is high is smaller than the cylinder inner volume (V0b) in the control phase αb in which the piston position is low. This means that the cylinder inner volume V0 has a relationship V0a<V0b.

Now, this cylinder inner volume V0 is a volume surrounded by a shape of an inner surface of the combustion chamber on the cylinder head side, a shape of the crown surface 2a of the piston 2, an inner diameter of the cylinder block 02, an inner diameter of a not-illustrated head gasket, and the like at the compression top dead center, i.e., a volume of gas (the air-fuel mixture) at the compression top dead center.

On the other hand, in FIG. 5, focusing on the piston position at the intake bottom dead center, a piston position (YCa) in the control phase αa indicated by the broken line, and a piston position (YCb) in the control phase αb indicated by the solid line are located at approximately same positions. Therefore, a compression stroke (LC), which is a length from the compression top dead center to the intake bottom dead center, has the following relationship. A compression stroke (LCa) in the control phase αa and a compression stroke (LCb) in the control phase αb have a relationship LCa>LCb therebetween.

Similarly, focusing on the piton position at the expansion bottom dead center, both a piston position (YEa) in the control phase αa indicated by the broke line and a piston position (YEb) in the control phase αb indicated by the solid line are located considerably low positions compared to the piston positions (YCa) and (YCb) at the intake bottom dead center. The piston position (YEb) in the control phase αb is located at a slightly higher position than the piston position (YEa) in the control phase αa, but, nevertheless is located at a considerably low position compared to the piston positions (YCb) and (YCa) at the intake bottom dead center.

Therefore, a length of an expansion stroke (LE), which is a length from the compression top dead center to the expansion bottom dead center, is considerably long compared to the compression stroke (LC) in both the control phase αa and the control phase αb. The expansion stroke (LEa) in the control phase αa and the expansion stroke (LEb) in the control phase αb have a relationship LEa>LEb therebetween.

From these relationships, the compression stroke (LCa) in the control phase αa and the compression stroke (LCb) in the control phase αb, and the expansion stroke (LEa) in the control phase αa and the expansion stroke (LEb) in the control phase αb have a relationship LEa>LEb>LCa>LCb among them.

Now, a mechanical compression ratio (Ca), which is a mechanical compression ratio in the control phase αa, and a mechanical expansion ratio (Ea), which is a mechanical expansion ratio in the control phase αa, will be analyzed.

Assuming that S represents an area of the bore (a cylinder inner diameter), a cylinder inner volume VCa at the intake bottom dead center is expressed as VCa=V0a+S×LCa. Therefore, the mechanical compression ratio (Ca) is expressed as Ca=VCa÷V0a=(V0a+S×LCa)÷V0a=1+S×LCa÷V0a. On the other hand, a cylinder inner volume VEa at the expansion bottom dead center is expressed as VEa=V0a+S×LEa÷V0a. Therefore, the mechanical expansion ratio Ea is expressed as Ea=VEa÷V0a=(V0a+S×LEa)÷=V0a=1+S×LEa÷V0a.

Therefore, in the case of the control phase αa, since the stroke relationship is LEa>LCa as illustrated in FIG. 5, the mechanical ratio has a relationship of the mechanical expansion ratio (Ea)>the mechanical compression ratio (Ca). Now, assuming that a relative ratio D is defined to be D=the mechanical expansion ratio E÷the mechanical compression ratio C, a relative ratio Da is expressed as Da=Ea÷Ca>1 in the case of the control phase αa.

Similarly, a mechanical compression ratio (Cb), which is a mechanical compression ratio in the control phase αb, and a mechanical expansion ratio (Eb), which is a mechanical expansion ratio in the control phase αb, will be described.

A cylinder internal volume CVb at the intake bottom dead center is expressed as VCb=V0b+S×LCb. Therefore, the mechanical compression ratio Cb is expressed as Cb=VCb÷V0b=(V0b+S×LCb)÷V0b=1+S×LCb÷V0b. On the other hand, a cylinder internal volume VEb at the expansion bottom dead center is expressed as VEb=V0b+S×LEb. Therefore, the mechanical expansion ratio Eb is expressed as Eb=VEb÷V0b=(V0b+S×LEb)÷V0b=1+S×LEb÷V0b.

Therefore, in the case of the control phase αb, since the stroke relationship is LEb>LCb as illustrated in FIG. 5, the mechanical ratio also has a relationship of the mechanical expansion ratio (Eb)>the mechanical compression ratio (Ca). Since the relative ratio D is D=the mechanical expansion ratio E÷the mechanical compression ratio C, a relative ratio Db is expressed as Db=Eb÷Cb>1 in the case of the control phase αb.

Next, the control phase αa and the control phase αb will be compared to each other. As described above, the cylinder inner volume (V0a) in the control phase αa and the cylinder inner volume (V0b) in the control phase αb have the relationship V0a<V0b therebetween, and, similarly, the compression stroke (LC) also has the relationship LCa>LCb.

Therefore, the mechanical compression ratio also has a relationship Ca>Cb according to the above-described equation expressing the mechanical compression ratio C. Further, the expansion stroke (LE) also has the relationship LEa>LEb, and therefore the mechanical expansion ratio also has a relationship Ea>Eb.

Therefore, the characteristic of the control phase αa can be said to be a characteristic suitable for a partial load. In other words, the control phase αa has a significantly high mechanical expansion ratio Ea, thereby realizing large expansion work due to that and thus bringing about an effect of improving thermal efficiency and improving a fuel efficiency performance.

Further, the control phase αa has a relatively high mechanical compression ratio (Ca), and therefore can relatively increase a gas temperature in the cylinder at the compression top dead center. Therefore, the control phase αa can excellently maintain the combustion, and improve the fuel efficiency for the partial load from this viewpoint as well. Further, a piston position (Y′0a) at the exhaust (intake) top dead center is located at a lower position than the piston position (Y0a) at the compression top dead center, so that the control phase αa can increase the cylinder inner volume at the exhaust (intake) top dead center to increase a so-called inner EGR, thereby further increasing the gas temperature in the cylinder to improve the combustion and reducing a pump loss to further improve the thermal efficiency, thus bringing about an effect of further enhancing the fuel efficiency effect for the partial load.

On the other hand, conversely, the characteristic of the control phase αb can be said to be a characteristic suitable for the high load. More specifically, the control phase αb has a relatively low mechanical compression ratio Cb, and therefore can relatively decrease the gas temperature in the cylinder at the compression top dead center and also relatively decrease a compression pressure, thereby bring about an effect of preventing or reducing a so-called knocking phenomenon. Then, the mechanical expansion ratio Eb is kept at a higher ratio than the mechanical compression ratio Cb, and therefore the control phase αb can enhance a torque along with realizing large expansion work and high thermal efficiency and improving the fuel efficiency.

Further, at the exhaust (intake) top dead center, a piston position (Y′0b) is located at an approximately same position as the piston position (Y0b) at the compression top dead center. In other words, the control phase αb does not have such a characteristic that the piston position (Y′0a) at the exhaust top dead center is located at the lower position than the piston position (Y0a) at the compression top dead center like the characteristic of the control phase αa, and does not especially lead to the increase in the cylinder inner volume at the exhaust (intake) top dead center like the control phase αa. Therefore, the control phase αb does not especially cause a large amount of the high-temperature inner EGR to remain in the cylinder in the course of the downward movement of the piston and the advance of the intake like the control phase αa, thereby bringing about an effect of succeeding in also preventing or reducing a degree of the increase in the temperature in the cylinder and thus preventing or reducing deterioration of the knocking resistance performance.

Further importantly, the control phase αb increases the thermal efficiency of the internal combustion engine due to the mechanical expansion ratio Eb higher than the mechanical compression ratio Cb and the increase in the expansion work, and therefore can reduce the temperature of the exhaust gas discharged from the internal combustion engine, thereby preventing or reducing thermal damage on a part in an exhaust system such as an exhaust manifold and an exhaust gas purification catalyst. In addition thereto, the control phase αb allows the internal combustion engine 01 to also prevent or reduce deterioration of exhaust emission by preventing or reducing thermal degradation of the exhaust gas purification catalyst.

Now, hypothetically supposing that the prevention or reduction of the knocking phenomenon is attempted by decreasing the mechanical compression ratio with use of the compression ratio adjusting apparatus according to PTL 1, a possible consequence in this case will be described now. As described above, the compression ratio adjusting apparatus according to PTL 1 is configured in such a manner that the mechanical expansion ratio is decreased to the same value as the mechanical compression ratio according to the reduction in the mechanical compression ratio. Due to this configuration, the compression ratio adjusting apparatus leads to a reduction in the expansion work of the engine and thus an undesirable reduction in the thermal efficiency, thereby ending up causing combustion energy to be undesirably consumed for increasing the temperature of the exhaust gas at a high rate.

As a result, this compression ratio adjusting apparatus leads to an undesirable further increase in the high temperature of the exhaust gas in the high load operation, thereby ending up undesirably facilitating the thermal damage on the part in the exhaust system such as the exhaust manifold and the exhaust gas purification catalyst. Along therewith, this compression ratio adjusting apparatus also ends up having such a problem that the torque further reduces and the fuel efficiency is further deteriorated according to the reduction in the thermal efficiency of the internal combustion engine.

Now, another hypothetically conceivable method is to increase an air-fuel ratio in an air-fuel mixture to reduce the temperature of the exhaust gas, but this case also raises a problem of further deteriorating the fuel efficiency. Further, delaying an ignition timing with an attempt to improve the knocking resistance performance leads to a further reduction in the thermal efficiency of the internal combustion engine in addition to a further increase in the temperature of the exhaust gas and thus deterioration of the thermal damage on the part in the exhaust system, which makes the deterioration of the torque and the fuel efficiency unavoidable.

In this manner, if the prevention or reduction of the knocking phenomenon is attempted by decreasing the mechanical compression ratio with use of the compression ratio adjusting apparatus discussed in PTL 1 at the time of the operation in the high load area of the internal combustion engine, this leads to the undesirable decrease in the mechanical expansion ratio to the same ratio along therewith, thereby increasing a risk of causing inconvenience like the above-described problems.

On the other hand, in the present embodiment, the compression ratio adjusting apparatus is configured to decrease the mechanical compression ratio at the time of the operation in the high load area of the internal combustion engine and set the mechanical expansion ratio at this time to a higher ratio than this mechanical compression ratio as described above, thereby becoming able to improve the above-described problems.

In FIG. 5, LIa and LIb each represent the intake stroke in the intake stroke, and L0a and L0b each represent the exhaust stroke in the exhaust stroke although being not described herein.

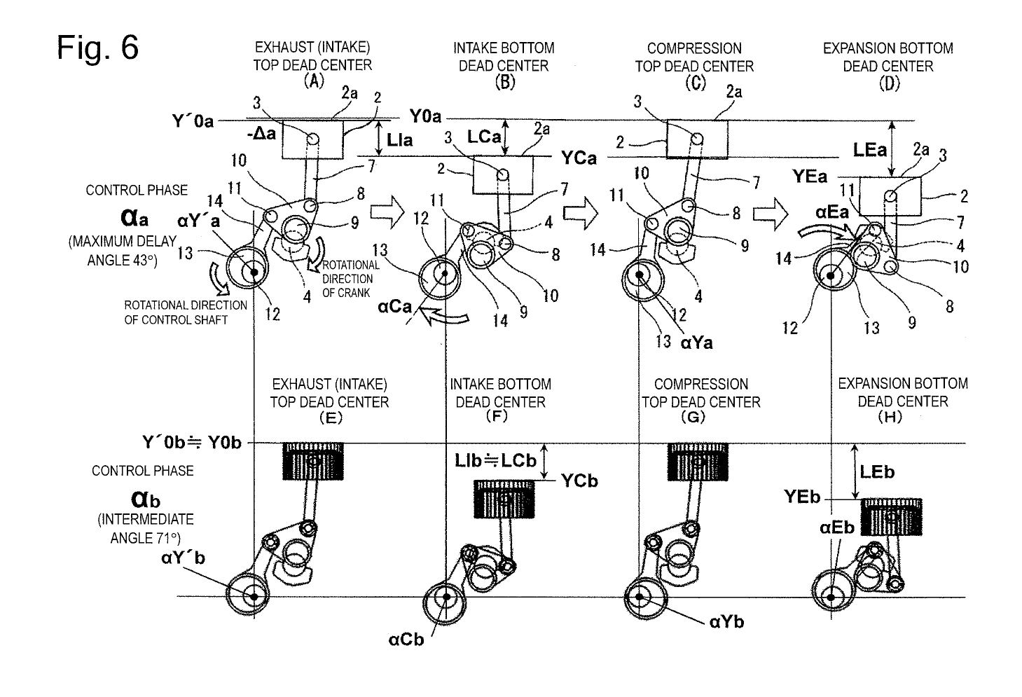

Next, a change in a mechanism posture in each of the strokes of the combustion cycle in each of the control phase αa and the control phase αb will be described with reference to FIGS. 6(A) to 6(D). This description will be able to make the characteristic of the change in the piston position illustrated in FIG. 5 further easily understandable. FIGS. 6(A) to 6(D) lined in an upper row illustrate the change in the mechanism posture in the control phase αa (the maximum delay angle state), and FIG. 6(E) to 6(H) lined in a lower row illustrate the change in the mechanism posture in the control phase αb (the intermediate angle state).

<<Exhaust (Intake) Top Dead Center>> Focusing on an eccentricity direction (αY′) of the eccentric cam portion at the exhaust (intake) top dead center, an eccentricity direction (αY′a) of the eccentric cam portion in the control phase αa illustrated in FIG. 6(A) is oriented in a direction slightly approaching the control link 14. Due to this posture, the control link 14 slightly pushes up the second coupling pin 11 to the upper right, and the lower link 10 is rotated in the clockwise direction with the crank pin 9 serving a supporting point therefor. Due to this movement, the position of the first coupling pin 8 is slightly lowered, and thus the piston 2 is slightly pulled down by the upper link 7. As a result, the piston position (Y′0a) at the exhaust (intake) top dead center is located at the slightly lower position (−Δa) than the piston position (Y0a) at the compression top dead center.

On the other hand, an eccentricity direction (αY′b) of the eccentric cam portion in the control phase αb illustrated in FIG. 6(E) is oriented in a direction generally perpendicular to the control link 14 (similarly to αYb). Due to this posture, the piston position (Y′0b) at the exhaust (intake) top dead center is located at the approximately same position as the piston position (Y0b) at the compression top dead center. Then, the piston position (Y′b) at the exhaust (intake) top dead center is located at the higher position than the piston position (Y′0a), which is the exhaust (intake) top dead center in the control phase αa.

<<Intake Bottom Dead Center>> Focusing on an eccentricity direction (αC) of the eccentric cam portion at the intake bottom dead center, both eccentricity directions (αCa) and (αCb) of the eccentric cam portion in the control phase αa illustrated in FIG. 6(B) and the control phase αb illustrated in FIG. 6(F) are oriented in an opposite direction from the control link 14. Due to this posture, the control link 14 pulls down the second coupling pin 11 to the lower left, and the lower link 10 is rotated in the counterclockwise direction with the crank pin 9 serving as a supporting point therefor. Due to this movement, the position of the first coupling pin 8 is raised, and thus the piston 2 is pushed up by the upper link 7. As a result, the piston position (YCa) at the intake bottom dead center in the control phase αa and the piston position (YCb) at the intake bottom dead center in the control phase αa are located at the approximately same positions that are relatively high positions. Now, YCa and YCb are located at the approximately same positions because an angle formed by the direction of the control link 14 and the direction of αC is approximately the same betweenα αCa and αCb (symmetrically opposite placement).

<<Compression Top Dead Center>> Focusing on an eccentricity direction (αY) of the eccentric cam portion at the compression top dead center, in the control phase αa illustrated in FIG. 6(C), a direction (αYa) of the eccentric cam portion is orientated in a direction slightly separating away from the control link 14. Due to this posture, the control link 14 slightly pushes down the second coupling pin 11 to the lower left, and the lower link 10 is rotated in the counterclockwise direction with the crank pin 9 serving as a supporting point therefor. Due to this movement, the position of the first coupling pin 8 is raised, and thus the piston 2 is pushed up by the upper link 7. As a result, the piston position (Y0a) at the compression top dead center is located at the relatively high positon. Therefore, the mechanical compression ratio Ca has the slightly high value.

On the other hand, focusing on an eccentricity direction (αY) of the eccentric cam portion in the control phase αb illustrated in FIG. 6(G), an eccentricity direction (αYb) of the eccentric cam portion is oriented in a direction generally orthogonal to the control link 14, as a result of which the piston position (Y0b) at the compression top dead center is located at the relatively low position. Therefore, the mechanical compression ratio Cb has the slightly low value. The above-described mechanical compression ratio Cb has the low value relative to the above-described mechanical compression ratio Ca because YCa and YCb at the intake bottom dead center are located at the approximately same positions as described above while Y0b is lower than Y0a at the compression top dead center.

<<Expansion Bottom Dead Center>> Focusing on an eccentricity direction (αE) of the eccentric cam at the expansion bottom dead center, both in the control phase αa illustrated in FIG. 6(D) and the control phase αb illustrated in FIG. 6(H), the eccentricity direction (αE) of the eccentric cam is oriented in a direction toward the control link 14. Due to this posture, the control link 14 pushes up the second coupling pin 11 to the upper right, and the lower link 10 is rotated in the clockwise direction with the crank pin 9 serving as a supporting point therefor. Due to this movement, the position of the first coupling pin 8 is lowered, and thus the piston 2 is pulled down by the upper link 7. As a result, the piston position (YEa) at the expansion bottom dead center in the control phase αa and the piston position (YEb) at the expansion bottom dead center in the control phase αb are located at the sufficiently low positions compared to the piston position (YCa) at the intake bottom dead center in the control phase as and the piston position (YCb) at the intake bottom dead center in the control phase αb.

Now, the piston position (YEb) at the expansion bottom dead center in the control phase αb is located at the slightly higher position than the piston position (YEa) at the expansion bottom dead center in the control phase as because the eccentricity direction (αEb) of the eccentric cam portion is not oriented in the direction toward the control link 14 as exactly as the eccentricity direction (αEa) of the eccentric cam portion is oriented, and is slightly angled therefrom.

These arrangements allow both the control phases αa and αb to acquire such a characteristic that the mechanical expansion ratio becomes high relative to the mechanical compression ratio. Further, such a characteristic that the mechanical expansion ratio is slightly lower in the control phase αb than in the control phase as can be made sense of by the above-described difference in the eccentricity direction of the eccentric cam portion.

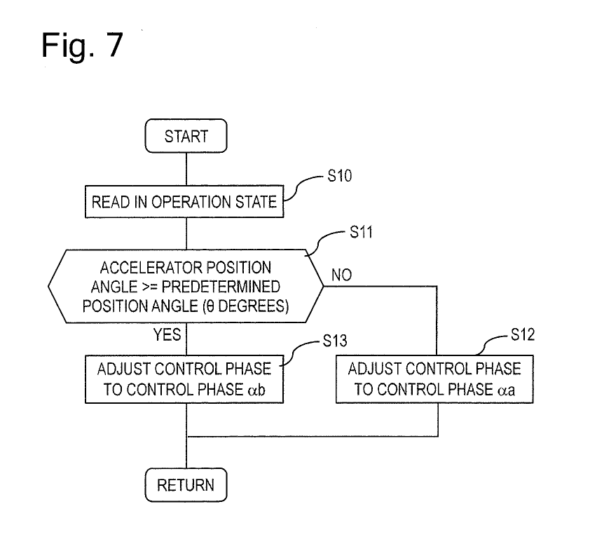

Next, specific control corresponding to the operation state using the above-described compression ratio adjusting apparatus will be described with reference to FIG. 7. FIG. 7 illustrates a specific control flowchart thereof.

First, in step S10, the compression ratio adjusting apparatus reads in various kinds of operation information including an accelerator pressing amount (an accelerator position angle) as a current operation state of the engine. In step S11, the compression ratio adjusting apparatus determines that the current operation state is in the partial load area (or a low load area) if the accelerator position angle is smaller than a predetermined position angle (θ degrees). Then, the processing proceeds to step S12, in which the compression ratio adjusting apparatus changes the control phase to the above-described control phase αa (the high mechanical expansion ratio Ea) suitable for the partial load area, thereby improving the fuel efficiency in the partial load area.

On the other hand, the compression ratio adjusting apparatus determines that the current operation state is in the high load area if the accelerator position angle is the predetermined position angle (θ degrees) or larger. Then, the processing proceeds to step S13, in which the compression ratio adjusting apparatus changes the control phase to the above-described control phase αb (the low mechanical compression ratio Cb and the high mechanical expansion ratio Eb) suitable for the high load area, thereby improving the knocking resistance performance, the emission performance, the torque performance, the fuel efficiency, and the like in the high load area. Further, the compression ratio adjusting apparatus prevents or cuts down the increase in the temperature of the exhaust gas, thereby preventing or reducing the occurrence of the thermal damage on the part in the exhaust system such as the exhaust manifold and the exhaust gas purification catalyst. Such an effect can be acquired especially noticeably at full load in which the accelerator position angle is in an approximately fully opened state.

Now, the high mechanical expansion ratio (Eb) in the high load area is slightly lower than the high mechanical expansion ratio (Ea) in the partial load area because these ratios are set in consideration of a seizure resistance performance of the piston in the high load area. More specifically, this is because, hypothetically supposing that the expansion stroke (LEb) and the mechanical expansion ratio (Eb) in the expansion stroke increase excessively, a length of a sliding movement (a speed of the sliding movement) of the piston may increase in a state receiving the combustion pressure and the seizure resistance performance may be deteriorated in the high load area because a combustion pressure and a temperature load acting on the piston increase in the high load area.

Therefore, the expansion stroke (LEb) and the mechanical expansion ratio (Eb) are set to a slightly shorter stroke and a slightly lower ratio than the expansion stroke (LEa) and the mechanical expansion ratio (Ea) in the partial load area, respectively. In other words, in the partial load area where the risk of the piston seizure is low, the expansion stroke (LEa) and the mechanical expansion ratio (Ea) are set to a further long stroke and a further high ratio, which can increase the expansion work and enhance the fuel efficiency effect. Such a fuel efficiency effect can be acquired in a further wide operation area and the fuel efficiency can be further improved in an actual operation, by setting the above-described predetermined accelerator position angle (θ degrees) to a degree as large as around the fully opened degree.

As described above, in the present embodiment, the compression ratio adjusting apparatus is configured to relatively decrease the mechanical compression ratio in the high load area compared to in the partial load area, and also adjust the mechanical expansion ratio in the high load area at this time to a high ratio relative to the mechanical compression ratio in the high load area. According to this configuration, the compression ratio adjusting apparatus performs control of decreasing the mechanical compression ratio in the high load area of the internal combustion engine and also setting the mechanical expansion ratio at this time to a higher ratio than the mechanical compression ratio, thereby becoming able to improve the knocking resistance performance and prevent or cut down the increased in the temperature of the exhaust gas.

### Second Embodiment

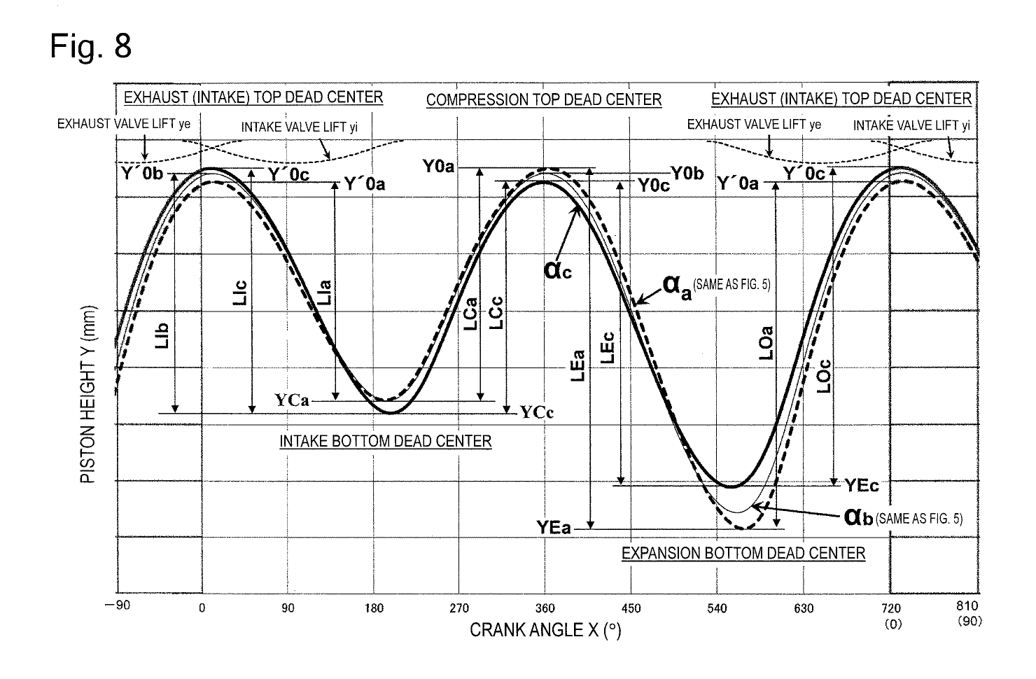

Next, a second embodiment of the present invention will be described. In the first embodiment, the compression ratio adjusting apparatus controls the control phase αa (the maximum delay angle) and the control phase αb (the intermediate angle) in the partial load area and the high load area. On the other hand, the present embodiment will be described as an example in a case where an engine load (an engine torque) can be further increased due to supercharging. In the following description, the second embodiment will be described with reference to FIGS. 8 to 10.

In the present embodiment, the compression ratio adjusting apparatus is configured to advance the eccentric cam portion to the control phase αc (the maximum advance angle, for example, 100 degrees) on a further advance angle side in a further high load area of the internal combustion engine. Especially, the compression ratio adjusting apparatus is configured to be able to improve the knocking resistance performance and also prevent or cut down the increase in the temperature of the exhaust gas even at the time of supercharging in an internal combustion engine including a supercharging machine such as a turbocharger or a supercharger.

FIG. 8 illustrates a piston position change characteristic in the control phase αc (the maximum advance angle) in addition to the piston position change characteristics (the control phases αa and αb) illustrated in FIG. 5. Then, in FIG. 8, a broken line indicates the control phase αa, a thin solid line indicates the control phase αb, and a thick solid line indicates the control phase αc added in the present embodiment.

In the characteristic in the control phase ac, the piston position at the compression top dead center is further lowered from the piston position (Y0b) to a piston position (Y0c) compared to the characteristic in the control phase αb (the thin line). In other words, the knocking resistance performance is further improved as a further low mechanical compression ratio (Cc) than the control phase αb. Further, the piston position at the exhaust (intake) top dead center is further raised from the piston position (Y′0b) to a piston position (Y′0c). In other words, the compression ratio adjusting apparatus is configured to further reduce the cylinder inner volume at the exhaust (intake) top dead center, thereby further reducing the high-temperature inner EGR and thus further improving the knocking resistance performance.

In this manner, in the present embodiment, the piston position (Y0c) at the compression top dead center is located at the relatively low position, and the piston position (Y′0c) at the exhaust (intake) top dead center is located at the relatively high position. On the other hand, a piston position (YCc) at the intake bottom dead center is located at a lower position than the piston position (YCa) in the control phase αand the piston position (YCb) in the control phase αb. In addition thereto, the piston position (Y′0c) at the exhaust (intake) top dead center is located at the high position as described above. As a result, an intake stroke (LIc) in the control phase αc is elongated to a longer stroke than the intake stroke (LIb) in the control phase αb, and an effect of further improving the torque can be acquired due to an increase in an intake air amount according to this increase in the intake stroke.

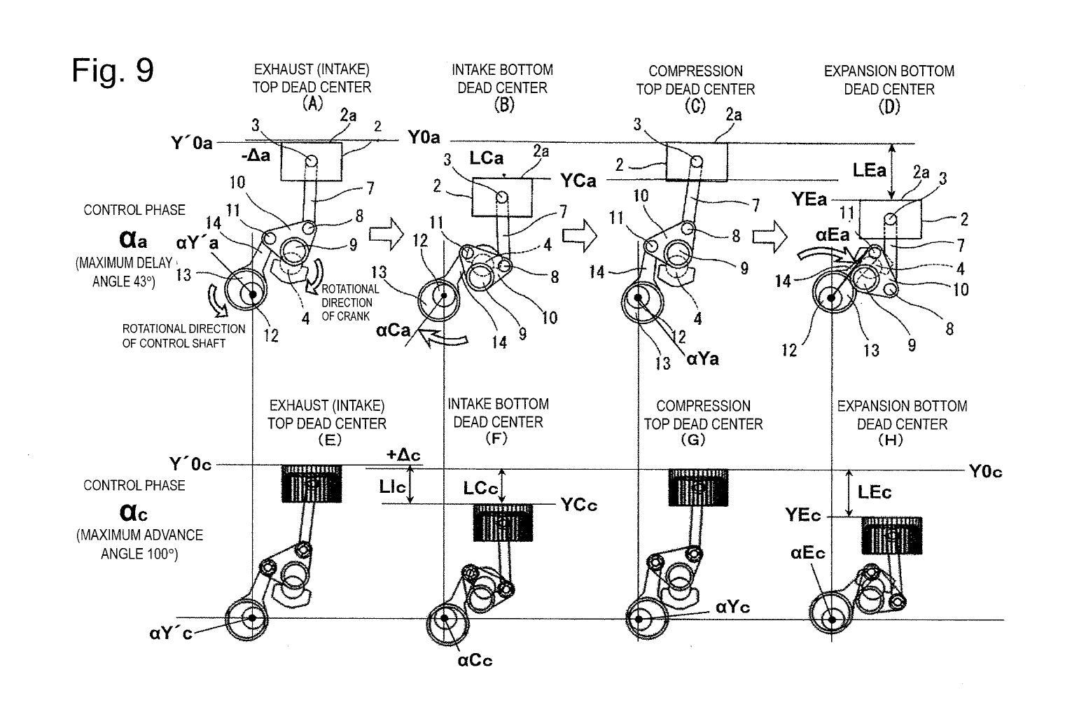

Next, the change in the mechanism posture in each of the strokes of the combustion cycle in each of the control phase αa and the control phase αc will be described with reference to FIGS. 9(A) to 9(D). This description will be able to make the characteristic of the change in the piston position illustrated in FIG. 8 further easily understandable. FIGS. 9(A) to 9(D) lined in an upper row illustrate the change in the mechanism posture in the control phase αa (the maximum delay angle state), and FIGS. 9(E) to 9(H) lined in a lower row illustrate the change in the mechanism posture in the control phase αc (the maximum advance angle state).

The characteristic in the control phase αc is close to the characteristic in the control phase αb, but is a characteristic established in consideration of being used in the further higher high load area (a high supercharging pressure area) than the high load area for which the control phase αb is used. The control phase αa illustrated in FIGS. 9(A) to 9(H) is the same as the control phase αa illustrated in FIGS. 6(A) to 6(H), and therefore a description thereof will be omitted here. Further, the present embodiment controls the eccentric cam portion in a further advance angle direction more advanced than the control phase αb, and therefore a comparison with the control phase αb will also be described along with the comparison with the control phase αa in the following description.

<<Exhaust (Intake) Top Dead Center>> Focusing on the eccentricity direction (αY′) of the eccentric cam portion at the exhaust (intake) top dead center, an eccentricity direction (αY′c) in the control phase αc is shifted in a direction slightly separating farer away from the control link 14 than the eccentricity direction (αY′b) in the control phase αb illustrated in FIG. 6(E), as indicated by the eccentricity direction (αY′c) in the control phase αc illustrated in FIG. 9(E). Due to this posture, the control link 14 slightly pulls down the second coupling pin 11 to the lower left, and the lower link 10 is rotated in the counterclockwise direction with the crank pin 9 serving as a supporting point therefor. Due to this movement, the position of the first coupling pin 8 is raised, and thus the piston 2 is pushed up by the upper link 7. As a result, the piston position (Y′0c) at the exhaust (intake top dead center) is located at the higher position than the piston position (Y′0b) in the control phase αb, by which the cylinder inner volume at the exhaust (intake) top dead center is further reduced. Due to this reduction, the inner EGR can be further reduced.

<<Intake Bottom Dead Center>> Focusing on the eccentricity direction (αC) of the eccentric cam at the intake bottom dead center, an eccentricity direction (αCc) in the control phase αc is shifted in the direction slightly approaching the control link 14 compared to the eccentricity direction (αCb) in the control phase αb illustrated in FIG. 6(F), as indicated by the eccentricity direction (αC) of the eccentric cam illustrated in FIG. 9F. Due to this posture, the control link 14 slightly pushes up the second coupling pin 11 to the upper right, and the lower link 10 is rotated in the clockwise direction with the crank pin 9 serving as a supporting point therefor. Due to this movement, the position of the first coupling pin 8 is lowered, and thus the piston 2 is pulled down by the upper link 7. As a result, the piston position (YCc) at the intake bottom dead center is located at the lower position than the piston position (YCa) in the control phase αa and the piston position (YCb) in the control phase αb. This descent of the piston position and the above-described ascent of the piston position (Y′0c) at the exhaust (intake) top dead center leads to the increase in the intake stroke (LIc).

<<Compression Top Dead Center>> Focusing on the eccentricity direction (αY) of the eccentric cam at the compression top dead center, an eccentricity direction (αYc) in the control phase αc is shifted in the direction approaching the control link 14 compared to the eccentricity direction (αYb) in the control phase αb illustrated in FIG. 6(G), as indicated by the eccentricity direction (αYc) in the control phase αc illustrated in FIG. 9(G). Due to this posture, the control link 14 slightly pushes up the second coupling pin 11 to the upper right, and the lower link 10 is rotated in the clockwise direction with the crank pin 9 serving as a supporting point therefor. Due to this movement, the position of the first coupling pin 8 is lowered, and thus the piston 2 is pulled down by the upper link 7. As a result, the piston position (Y0c) at the compression top dead center is located at the lower position than the piston position (Y0b) in the control phase αb, and the mechanical compression ratio (Cc) has the lower value than the mechanical compression ratio (Cb) in the control phase αb.

<<Expansion Bottom Dead Center>> Focusing on the eccentricity direction (GE) of the eccentric cam at the expansion bottom dead center, an eccentricity direction (αEc) in the control phase αc is shifted in the direction separating away from the control link 14 compared to the eccentricity direction (αEb) in the control phase αb illustrated in FIG. 6(H), as indicated by the eccentricity direction (αEc) in the control phase αc illustrated in FIG. 9(H). Due to this posture, the control link 14 slightly pulls down the second coupling pin 11 to the lower left, and the lower link 10 is rotated in the counterclockwise direction with the crank pin 9 serving a supporting point therefor. Due to this movement, the position of the first coupling pin 8 is raised, and thus the piston 2 is pushed up by the upper link 7. As a result, the piston position (YEc) at the expansion bottom dead center is slightly raised. This raise makes the expansion stroke (LEc) slightly shorter than the expansion stroke (LEb) in the control phase αb in combination with the above-described descent of the compression top dead center position (Y0c), and also makes the mechanical expansion ratio (Ec) slightly lower than the mechanical expansion ratio (Eb) in the control phase αb similarly. However, this expansion stroke (LEc) is also sufficiently longer than the compression stroke (LCc), and, further, the mechanical expansion ratio (Ec) is also sufficiently higher than the mechanical compression ratio (Cc) as described above.

Due to such a configuration, the control phase αc has the characteristic indicated by the control phase αc in FIG. 8. In other words, the piston position change characteristic in the control phase αc illustrated in FIG. 8 is created based on the difference in the link posture due to the difference in the eccentricity phase of the control cam illustrated in FIGS. 9(A) to 9(H).

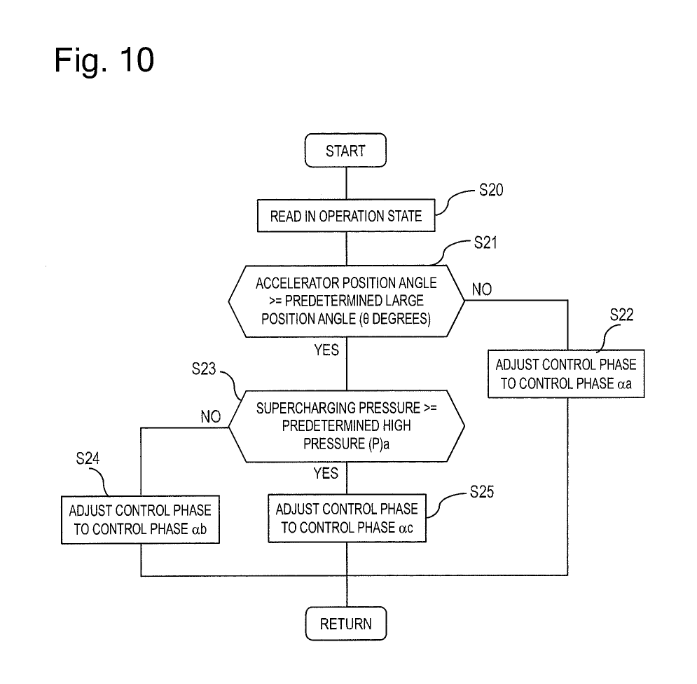

Next, specific control corresponding to the operation state using the above-described compression ratio adjusting apparatus will be described with reference to FIG. 10. FIG. 10 illustrates a specific control flowchart thereof.

In the present embodiment, the compression ratio adjusting apparatus is employed for the internal combustion engine including the supercharging machine such as the turbocharger or the supercharger mounted thereon. Generally, the supercharging machine is delayed in operation response and brings about such a phenomenon that the supercharging pressure increases with some delay, and the present flow is constructed as a control flow in consideration thereof.

First, in step S20, the compression ratio adjusting apparatus reads in various kinds of operation information including the accelerator pressing amount (the accelerator position angle) as the current operation state of the engine. In step S21, the compression ratio adjusting apparatus determines that the current operation state is in the partial load area (or a low load area) if the accelerator position angle is smaller than the predetermined position angle (θ degrees). Then, the processing proceeds to step S22, in which the compression ratio adjusting apparatus changes the control phase to the above-described control phase αa (the high mechanical compression ratio Ca and the considerably high mechanical expansion ratio Ea) suitable for the partial load area, thereby improving the fuel efficiency in the partial load area.

On the other hand, the compression ratio adjusting apparatus determines that the current operation state is in the high load area if the accelerator position angle is the predetermined position angle (θ degrees) or larger. Then, the processing proceeds to step S23, in which the compression ratio adjusting apparatus reads in the supercharging pressure from an intake manifold pressure or the like. Further, in step S23, the compression ratio adjusting apparatus determines that the current operation state is the high load but is not an excessively high load condition if the supercharging pressure is lower than a predetermined pressure (P). Then, the processing proceeds to step S24. In step S24, the compression ratio adjusting apparatus changes the control phase to the above-described control phase αb (the low mechanical compression ratio Cb and the high mechanical expansion ratio Eb) suitable for the high load area, thereby improving the knocking resistance performance, the emission performance, the torque performance, the fuel efficiency, and the like in the high load area. Further, the compression ratio adjusting apparatus prevents or cuts down the increase in the temperature of the exhaust gas, thereby preventing or reducing the occurrence of the thermal damage on the part in the exhaust system such as the exhaust manifold and the exhaust gas purification catalyst.

The compression ratio adjusting apparatus determines that the current operation state is the excessively high load area if the supercharging pressure is determined to be the predetermined pressure (P) or higher in step S23. Then, the processing proceeds to step S25, in which the compression ratio adjusting apparatus changes the control phase to the control phase αc. In this control phase αc, the mechanical compression ratio (Cc) has the further lower value than the mechanical compression ratio (Cb) in the control phase αb carried out in step S24. Therefore, the compression ratio adjusting apparatus can effectively prevent or reduce the knocking even at the time of the high supercharging in which the pressure and the temperature in the cylinder are high, thereby succeeding in improving the knocking resistance performance. Further, the cylinder inner volume at the exhaust (intake) top dead center is smaller than the volume in the case of the control phase αb, so that the compression ratio adjusting apparatus can further reduce the high-temperature inner EGR, thereby succeeding in further improving the knocking resistance performance from this viewpoint as well.

Further, the intake stroke (LIc) is longer than the intake stroke (LIb) in the control phase αb, whereby the compression ratio adjusting apparatus can increase the intake air amount by an amount corresponding thereto, thereby improving the engine torque required at the time of the excessively high load. Further, the expansion stroke (LEc) is long relative to the compression stroke (LCc), whereby the compression ratio adjusting apparatus can set the mechanical expansion ratio (Ec) to the sufficiency higher ratio than the mechanical compression ratio (Cc), thereby preventing or cutting down the increase in the temperature of the exhaust gas discharged from the internal combustion engine. As a result, the compression ratio adjusting apparatus can prevent the thermal damage on the exhaust manifold in the excessively high load area and prevent the thermal degradation of the exhaust gas purification catalyst similarly to the effects in the case of the first embodiment.

The expansion stroke (LEc) is slightly shorter than the expansion stroke (LEb) in the control phase αb, and the mechanical expansion ratio (Ec) is also slightly lower than the mechanical expansion ratio (Eb) in the control phase αb. This is because, hypothetically supposing that the expansion stroke (LEc) and the mechanical expansion ratio (Ec) in the expansion stroke are excessively long and high, respectively, the length of the sliding movement (the speed of the sliding movement) of the piston may increase in the expansion stroke during which the piston receives the combustion pressure and the seizure resistance performance may be deteriorated because the combustion pressure and the temperature load acting on the piston further increase at the time of the excessively high load.

Therefore, the expansion stroke (LEc) and the mechanical expansion ratio (Ec) are set to the slightly shorter stroke and the slightly lower ratio than the expansion stroke (LEb) and the mechanical expansion ratio (Eb) at the time of the high load with the supercharging pressure falling below the predetermined pressure P, respectively. In other words, the above-described risk of the seizure of the piston reduces as the load reduces, so that the present embodiment is configured to allow the expansion stroke to have the relationship “(LEc)<(LEb)<(LEa)”, and further allow the mechanical expansion ratio to also have the relationship “(Ec) <(Eb)<(Ea)” to increase the mechanical expansion ratio in this order, thereby improving the fuel efficiency effect.

The above-described embodiments have been described based on a single-cylinder internal combustion engine, but, obviously, the present invention can be applied to a multi-cylinder internal combustion engine, such as a two-cylinder internal combustion engine, a three-cylinder internal combustion engine, a four-cylinder internal combustion engine, and a six-cylinder internal combustion engine. In this case, the piston operation characteristics of all of the cylinders can be adjusted by a single phase change mechanism (a part of the variable compression ratio mechanism) if the internal combustion engine is an inline engine or by a pair of phase change mechanisms if the internal combustion engine is a V-type engine, and all of the cylinders can be controlled to a desired mechanical compression ratio and a desired mechanical expansion ratio by them.

Further, as the driven/driving rotational member (a part of the variable compression ratio mechanism) described in the embodiments, another appropriate driven/driving rotational member can be employed within a range that does not depart from the spirit of the present invention. For example, the present embodiments have been described referring to the example in which the pair of reduction gear pulleys is employed as the speed reduction mechanism that transmits the rotation of the crankshaft while slowing down this rotation to the half angular speed, but the present invention is not limited thereto.

Further, in the embodiments, the rotational direction of the crankshaft and the rotational direction of the eccentric cam are oriented in the opposite directions from each other, but may be oriented in the same direction. For example, each of the embodiments may be configured to transmit the rotation of the pulley on the crank side to the pulley on the eccentric control cam side while slowing down this rotation to the half angular speed via a timing belt (a timing chain). In this case, the rotational direction of the crankshaft and the rotational direction of the eccentric control cam are oriented in the same direction and the piston position change characteristic (the vertical axis) with respect to the rotation of the crankshaft (the horizontal axis) is horizontally inverted, but the operation itself is unchanged.

The present invention is not limited to the above-described embodiments, and includes various modifications. For example, the above-described embodiments have been described in detail to facilitate better understanding of the present invention, and are not necessarily limited to the configurations including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

For example, the link mechanism (a part of the variable compression ratio mechanism) is not limited to the specific example described in the embodiments, and may be a different link mechanism as long as this link mechanism is a mechanism capable of changing the characteristic of the stroke position of the piston in a similar manner.

Having described merely several embodiments of the present invention, those skilled in the art will be able to easily appreciate that the embodiments described as the examples can be modified or improved in various manners without substantially departing from the novel teachings and advantages of the present invention. Therefore, such modified or improved embodiments are intended to be also contained in the technical scope of the present invention. The above-described embodiments may also be arbitrarily combined.

The present application claims priority under the Paris Convention to Japanese Patent Application No. 2015-173660 filed on Sep. 3, 2015. The entire disclosure of Japanese Patent Application No. 2015-173660 filed on Sep. 3, 2015 including the specification, the claims, the drawings, and the abstract is incorporated herein by reference in its entirety.

### REFERENCE SIGN LIST

01 internal combustion engine

02 cylinder block

03 bore

1 piston position variable mechanism

2 piston

3 piston pin

4 crankshaft

5 link mechanism

6 phase change mechanism

7 upper link (first link)

8 first coupling pin

9 crank pin

10 lower link (second link)

11 second coupling pin

12 control shaft

13 eccentric cam portion

14 control link (third link)

15 first gear wheel (driving rotational member)

16 second gear wheel (driven rotational member)

1-12. (canceled)

13. A compression ratio adjusting apparatus for an internal combustion engine, comprising:
a variable compression ratio mechanism configured to change a mechanical compression ratio and a mechanical expansion ratio of a four cycle internal combustion engine by changing a stroke position of a piston of the internal combustion engine,
wherein the variable compression ratio mechanism relatively decreases the mechanical compression ratio in a high load area of the internal combustion engine, and relatively increases the mechanical expansion at this time, and
wherein the variable compression ratio mechanism is mechanically configured in such a manner that a piston position at an expansion bottom dead center when the mechanical compression ratio is increased to around a maximum ratio is located at the lowest position in a variable range in a partial load area of the internal combustion engine.

14. The compression ratio adjusting apparatus for the internal combustion engine according to claim 13, wherein the variable compression ratio mechanism sets the mechanical compression ratio in the high load area of the internal combustion engine to a lower ratio than the mechanical compression ratio in the partial load area of the internal combustion engine, and also sets the mechanical expansion ratio in the high load area of the internal combustion engine to a lower ratio than the mechanical expansion ratio in the partial load area of the internal combustion engine.

15. The compression ratio adjusting apparatus for the internal combustion engine according to claim 14, wherein the variable compression ratio mechanism sets the piston position at an exhaust (intake) top dead center to a higher position than the piston position at a compression top dead center in the high load area of the internal combustion engine.

16. The compression ratio adjusting apparatus for the internal combustion engine according to claim 15, wherein the variable compression ratio mechanism sets the piston position at the compression top dead center in the high load area of the internal combustion engine to a lower position than the piston position at the compression top dead center in the partial load area of the internal combustion engine.

17. The compression ratio adjusting apparatus for the internal combustion engine according to claim 15, wherein the variable compression ratio mechanism sets the piston position at the expansion bottom dead center in the high load area of the internal combustion engine to a higher position than the piston position at the expansion bottom dead center in the partial load area of the internal combustion engine.

18. The compression ratio adjusting apparatus according to claim 15, wherein the variable compression ratio mechanism sets the piston position at the exhaust (intake) top dead center in the high load area of the internal combustion engine to a higher position than the piston position at the exhaust (intake) top dead center in the partial load area of the internal combustion engine.

19. The compression ratio adjusting apparatus according to claim 15, wherein the variable compression ratio mechanism sets the piston position at an intake bottom dead center in the high load area of the internal combustion engine to the approximately same position as the piston position at the intake bottom dead center in the partial load area of the internal combustion engine.

20. A compression ratio adjusting apparatus for an internal combustion engine, comprising:
a variable compression ratio mechanism configured to change a mechanical compression ratio and a mechanical expansion ratio of a four cycle internal combustion engine by changing a stroke position of a piston of the internal combustion engine,
wherein the variable compression ratio mechanism is configured in such a manner that an expansion stroke is long relative to a compression stroke when an accelerator position angle is a predetermined position angle or larger.

21. The compression ratio adjusting apparatus for the internal combustion engine according to claim 20, wherein the variable compression ratio mechanism is configured in such a manner that the compression stroke of the piston in a high load area of the internal combustion engine is shorter than the compression stroke of the piston in a partial load area of the internal combustion engine, and the expansion stroke of the piston in the high load area of the internal combustion engine is shorter than the expansion stroke of the piston in the partial load area of the internal combustion engine.

22. The compression ratio adjusting apparatus for the internal combustion engine according to claim 21, wherein the variable compression ratio mechanism is capable of setting an intake stroke to a longer stroke than the compression stroke in the high load area of the internal combustion engine.

23. The compression ratio adjusting apparatus for the internal combustion engine according to claim 22, wherein the variable compression ratio mechanism is configured in such a manner that a piston position at an exhaust (intake) top dead center is higher than a piston position at a compression top dead center in the high load area of the internal combustion engine.

24. A method for controlling a compression ratio adjusting apparatus for an internal combustion engine, the compression ratio adjusting apparatus being capable of differently changing a mechanical compression ratio and a mechanical expansion ratio in a four cycle internal combustion engine for an automobile, the control method comprising:
determining whether an accelerator position angle is a predetermined position angle or larger, and determining a high load area of the internal combustion engine if determining that the accelerator position angle is the predetermined accelerator position angle or larger or determining a partial load area of the internal combustion engine if determining that the accelerator position angle is smaller than the predetermined accelerator position angle; [and]
controlling the mechanical compression ratio to a lower ratio than the mechanical compression ratio in the partial load area of the internal combustion engine and also controlling the mechanical expansion ratio to a lower ratio than the mechanical expansion ratio in the partial load area of the internal combustion engine, if determining the high load area of the internal combustion engine; and
setting the mechanical compression ratio to a high ratio relative to the mechanical compression ratio in the high load area of the internal combustion engine and also controlling the mechanical expansion ratio at this time to a high ratio relative to the mechanical expansion ration in the high load area of the internal combustion engine, and controlling a piston position at an expansion bottom dead center when the mechanical compression ratio is increased to around a maximum ratio to the lowest position in a variable range, if determining the partial load area of the internal combustion engine.

25. The compression ratio adjusting apparatus for the internal combustion engine according to claim 13, further comprising:
a first link coupled with the piston via a piston pin;
a second link swingably coupled with the first link via a first coupling pin and rotatably coupled with a crankshaft;
a control shaft configured to rotate at half an angular speed of the crankshaft;
a third link coupled with the second link via a second coupling pin and rotatably coupled with an eccentric cam of the control shaft; and
a relative phase variable mechanism capable of changing a relative phase between the crankshaft and the control shaft,
wherein, when the relative phase variable mechanism is controlled to a positon where the mechanical compression ratio is increased to around a maximum ratio in a variable range, an eccentricity direction of the eccentric cam at an expansion bottom dead center is located closest to the second link.

26. The method for controlling the compression ratio adjusting apparatus for the internal combustion engine according to claim 24, wherein the compression ratio adjusting apparatus includes
a first link coupled with the piston via a piston pin,
a second link swingably coupled with the first link via a first coupling pin and rotatably coupled with a crankshaft,
a control shaft configured to rotate at half an angular speed of the crankshaft,
a third link coupled with the second link via a second coupling pin and rotatably coupled with an eccentric cam of the control shaft, and
a relative phase variable mechanism capable of changing a relative phase between the crankshaft and the control shaft, and
wherein the control method further comprises performing control in such a manner that, when the relative phase variable mechanism is controlled to a positon where the mechanical compression ratio is increased to around a maximum ratio in a variable range, an eccentricity direction of the eccentric cam at an expansion bottom dead center is located closest to the second link.
